(19) United States
(12) Patent Application Publication
(10) Pub. No.: US 2024/0290159 A1
(43) Pub. Date: Aug. 29, 2024

(54) Bill Validator Mount for Electronic Gaming Machines

(71) Applicant: Aristocrat Technologies, Inc. (ATI), Las Vegas, NV (US)

(72) Inventors: Donald Rodd, Palm Beach Garden, FL (US); Timothy Barbour, Nolensville, TN (US)

(21) Appl. No.: 18/656,295

(22) Filed: May 6, 2024

Related U.S. Application Data
(63) Continuation of application No. 17/389,076, filed on Jul. 29, 2021, now Pat. No. 11,995,938.

(51) Int. Cl. G07D 11/125; G07D 11/10; G07F 17/32

(52) U.S. Cl. CPC G07D 11/125; G07D 11/10; G07F 17/3216; G07F 17/3246

(57) ABSTRACT

A bill validator mount holds a bill validator in a bill insertion position relative to an electronic gaming machine (EGM), such that the bill validator is configured to receive a bill from a player in the bill insertion position. The mount cage assembly facilitates tilting the bill validator backward from the bill insertion position to a servicing position that allows access to the bill validator for servicing from a back of the EGM cabinet. The mount cage assembly additionally facilitates lowering the bill validator from the bill insertion position to a collections position, such that the cash box can be accessed for collections. The mount cage assembly provides a way to easily service the bill validator while keeping the cash box secure.

### RELATED APPLICATIONS

The present application is a continuation of and claims priority to U.S. patent application Ser. No. 17/389,076, filed Jul. 29, 2021, and entitled “Bill Validator Mount for Electronic Gaming Machines” which is hereby incorporated by reference in its entirety.

The present application is related to U.S. patent application Ser. No. 16/857,290 filed May 5, 2020, U.S. patent application Ser. No. 29/658,892 filed Aug. 3, 2018, and U.S. patent application Ser. No. 29/696,682 filed Jun. 28, 2019, the disclosures of which are hereby incorporated by reference in their entirety.

### BACKGROUND

Electronic gaming machines (“EGMs”), or gaming devices, provide a variety of wagering games such as slot games, video poker games, video blackjack games, roulette games, video bingo games, keno games and other types of games that are frequently offered at casinos and other locations. Play on EGMs typically involves a player establishing a credit balance which may be accomplished by inputting a bill, such as money or another form of monetary credit (e.g., a credit ticket in a ticket-in ticket-out system) into a bill validator of the EGM. The bill validator receives the bill and stores or arranges the bills in a cash box. The bill validator needs to be accessible for servicing (e.g., to address a bill jam) as well as for collection (removing or replacing the cash box). However, it is also important that the bill validator be secured from unwanted access given that it is not uncommon for the cash boxes to store significant amounts of money. Some conventional bill validators are difficult to access for collection, are difficult to access for servicing, are not sufficiently secure, do not work well with a pedestal cabinet, etc.

### SUMMARY

Embodiments provide a bill validator mount that allows the bill validator to move from an bill insertion position for accepting bills from a player to a collections position for accessing the cash box, and from the bill insertion position to a servicing position for accessing jams or other servicing which does not require access to the cash box. In at least one example, the bill validator mount allows the bill validator to drop lower from the bill insertion position to the collections position and tilts backward from the bill insertion position to the servicing position. In some examples, the bill validator mount does not allow access to the cash box in the servicing position.

An embodiment provides a bill validator mount including a support bracket and a mount cage assembly. The support bracket is configured to be coupled to a bill validator and the mount cage assembly is configured to receive the support bracket, the bill validator, and a cash box. The mount cage assembly is also configured to hold the bill validator in a bill insertion position relative to an electronic gaming machine (EGM), such that the bill validator is configured to receive a bill from a player in the bill insertion position. The mount cage assembly is further configured to tilt the bill validator backward from the bill insertion position to a servicing position that allows access to the bill validator for servicing.

Another embodiment provides an electronic gaming machine (EGM) including a cabinet, a player input interface positioned on the cabinet, and a bill validator assembly positioned in the cabinet. The bill validator assembly includes a bill validator configured to receive a bill from a player, a cash box configured to store the bill, and a bill validator mount holding the bill validator and the cash box. The bill validatory mount includes a support bracket coupled to the bill validator, and a mount cage assembly coupled to the support bracket and configured to position the bill validator to receive the bill from the player in a bill insertion position. The mount cage assembly is configured to facilitate movement of the bill validator in a first direction from the bill insertion position to a servicing position. The mount cage assembly is also configured to facilitate movement of the bill validator in a second direction from the bill insertion position to a collections position, with the first direction being different than the second direction.

Another embodiment provides a method which includes providing or obtaining a bill validator mount positioned in an electronic gaming machine (EGM), such that a bill validator coupled to the bill validator mount is in a bill insertion position for receiving a bill from a player and a cash box is housed by the bill validator mount within a cabinet of the EGM. The method further includes accessing a handle associated with a cam cage assembly of the bill validator mount from a front side of the cabinet and pulling the handle to move the bill validator from the bill insertion position to a collections position to provide access to a door lock assembly securing the cash box. The method additionally includes accessing the bill validator from a back side of the cabinet and pulling the bill validator toward a back of the cabinet to move the bill validator from the bill insertion position to a servicing position.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 is an exemplary diagram showing a pedestal EGM, in accordance with at least one embodiment.

FIG. 4. is an exemplary diagram showing a perspective view of the pedestal system of FIG. 3 in an open position, in accordance with at least one embodiment.

FIG. 5A is an isometric view of a mount cage assembly of a bill validator mount, in accordance with at least one embodiment.

FIG. 5B is an isometric view of a support bracket of a bill validator mount, in accordance with at least one embodiment.

FIG. 5C is an isometric view of the support bracket of FIG. 5B coupled to a bill validator, in accordance with at least one embodiment.

FIGS. 6A-6E are isometric views of a bill validator assembly illustrating movement of the bill validator from a bill insertion position to a collections position, in accordance with at least one embodiment.

FIG. 6F is a flow chart of an example method of accessing the cash box for a cash drop, in accordance with at least one embodiment

FIGS. 7A-7D are isometric views of a bill validator assembly illustrating movement of the bill validator from the bill insertion position to a servicing position, in accordance with at least one embodiment.

FIG. 7E is a flow chart of an example method of accessing the bill validator for servicing, in accordance with at least one embodiment.

### DETAILED DESCRIPTION

The present disclosure is generally directed to providing a bill validator mount that allows the bill validator to be positioned in a bill insertion position for receiving a bill (e.g., money or ticket) from a player, and moved from the bill insertion position to a collections position and from the bill insertion position to a servicing position. The bill validator mount allows the bill validator to be lowered from the bill insertion position to the collections position to allow easy access to the cash box for collections, such as removing or replacing the cash box. The bill validator mount allows the bill validator to be tilted backward from the bill insertion position to the servicing position to allow easy access for servicing the bill validator, such as removing a bill jam, removing the bill validator, or the like. Generally, the bill validator mount secures the cashbox while allowing access to the bill validator for servicing and only allows for removal of the bill validator or access to the cash box when a door locking assembly has been unlocked, for example with a key provided to those with cash box credentials (credentials to access the cash box for collections or otherwise). As such, the bill validator mount of the present disclosure allows access to the bill validator for servicing by technicians or other personnel that do not have cash box credentials (though they may still be required to be credentialed operators such as service operations, service technicians, or other support personnel to get access to the cabinet). As such, a person with cash box credentials is not required for a bill validator servicing operation since the cash box will be kept secure and not accessible. Further, the different location for the collections position relative to the servicing position facilitates easy access and operation for each of servicing and collections.

The bill validator for an EGM must contain a secure tamper resistant container known as a cash box. Currency, gaming vouchers, and coupons inserted into the bill validator are deposited into the cash box until they are retrieved by casino personnel. For example, casino personnel often perform a cash drop (remove currency, gaming vouchers, and coupons from the cash box) at hours when the machines are not busy (for example, at night). The disclosed bill validator mount allows for an easy, quick, and secure cash drop, which is beneficial for the purposes of efficiency, security, and safety. Further, the disclosed bill validator mount allows for access to the cash box for a cash drop without disturbing other components of the EGM, such as the display or the user interface.

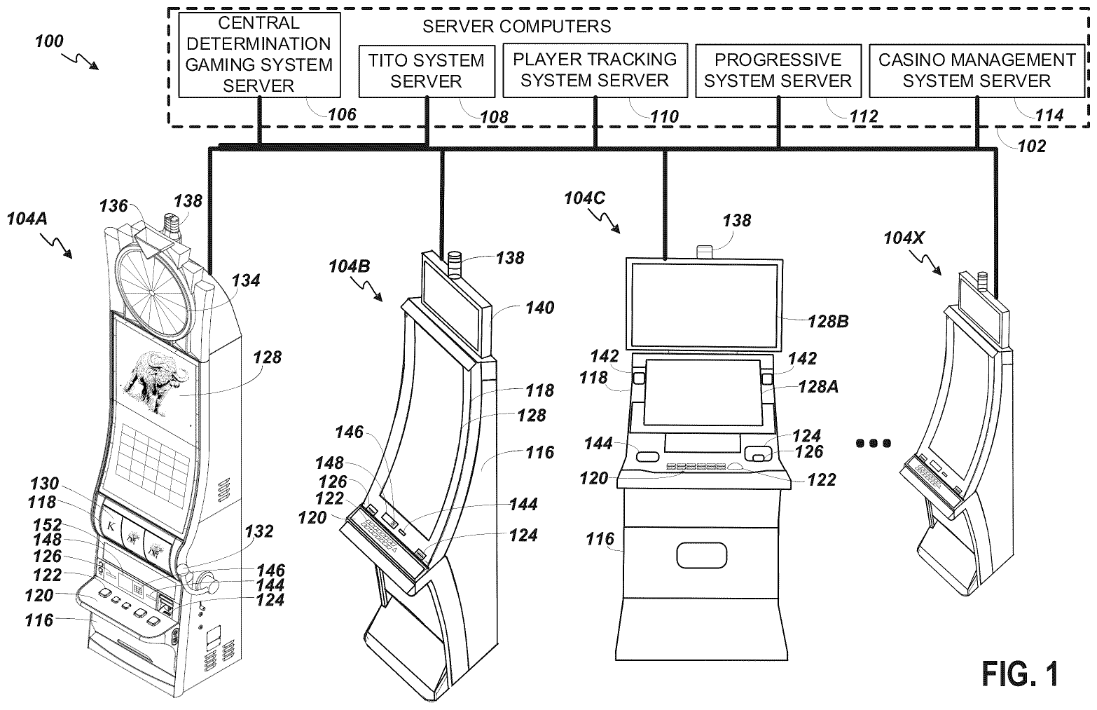

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In some examples, the buttons 122 in the button deck 120 can be physical buttons, or other player-actuatable selection elements, such as switches, dials, knobs, and the like. In further examples, the button deck 120 can be a virtual button deck and can be, or include, a display, such as a capacitive touchscreen. The buttons 122 can be virtual buttons, or other selection elements, that can be actuated through suitable player interaction (e.g., by performing pressing, swiping, dragging, or similar actions on the display of the virtual button deck 120). The virtual button deck can include a combination of pushbuttons and virtual buttons. Suitable virtual button decks 120 include the virtual button deck included in the Helix XT™ model gaming device manufactured by Aristocrat® Technologies, Inc. Although described with respect to the gaming device 104A, the button decks 120 of one or both of gaming devices 104B or 104C can be virtual button decks having virtual buttons 122 and/or pushbuttons 122.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), win paths (e.g. paylines), pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

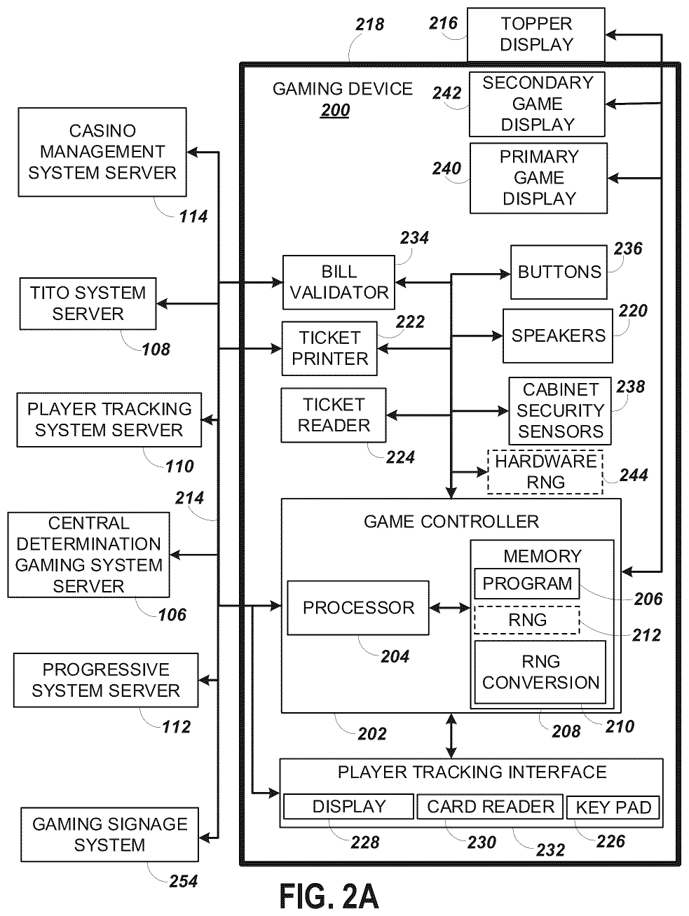

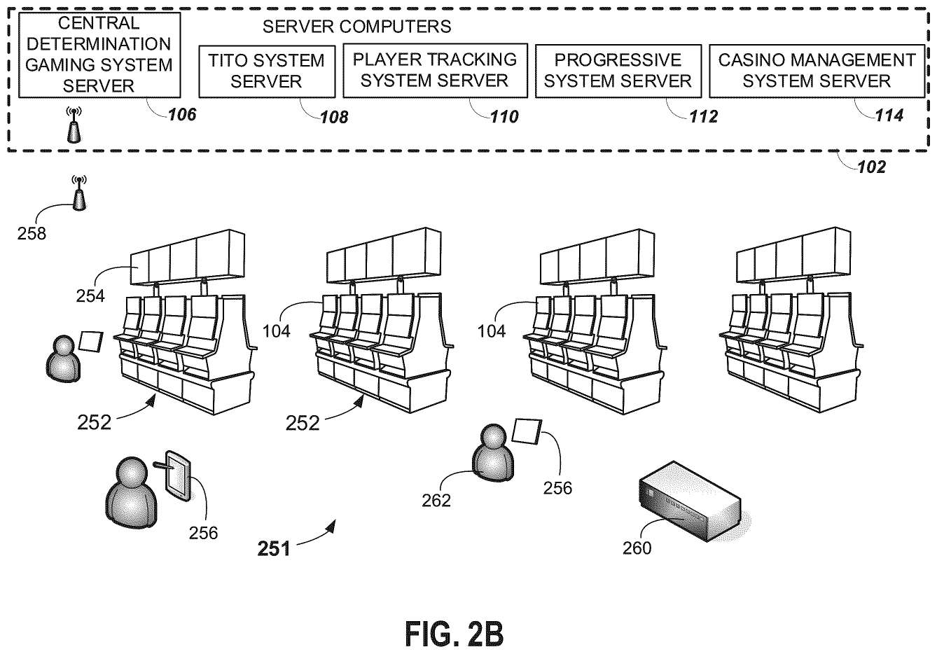

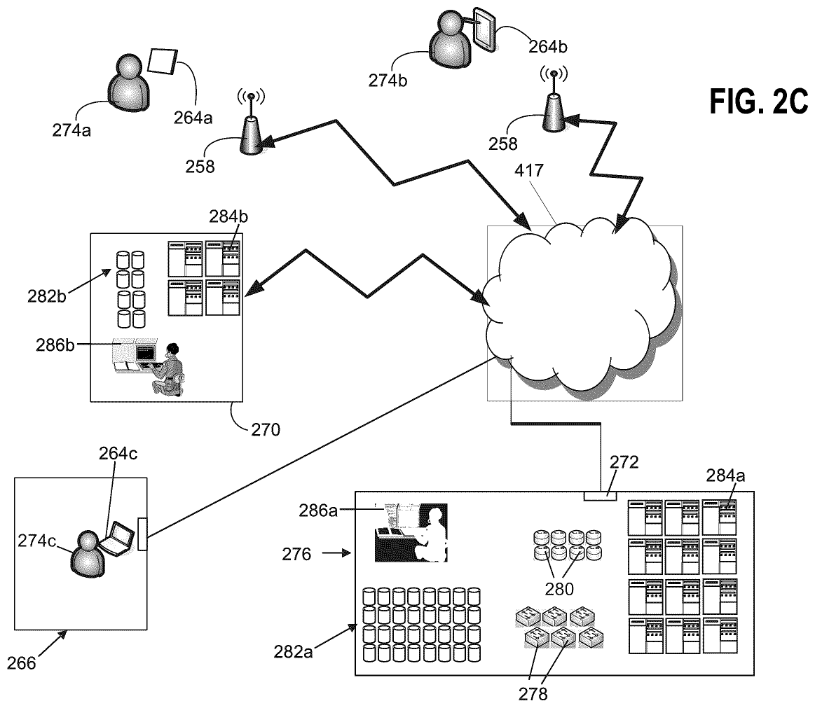

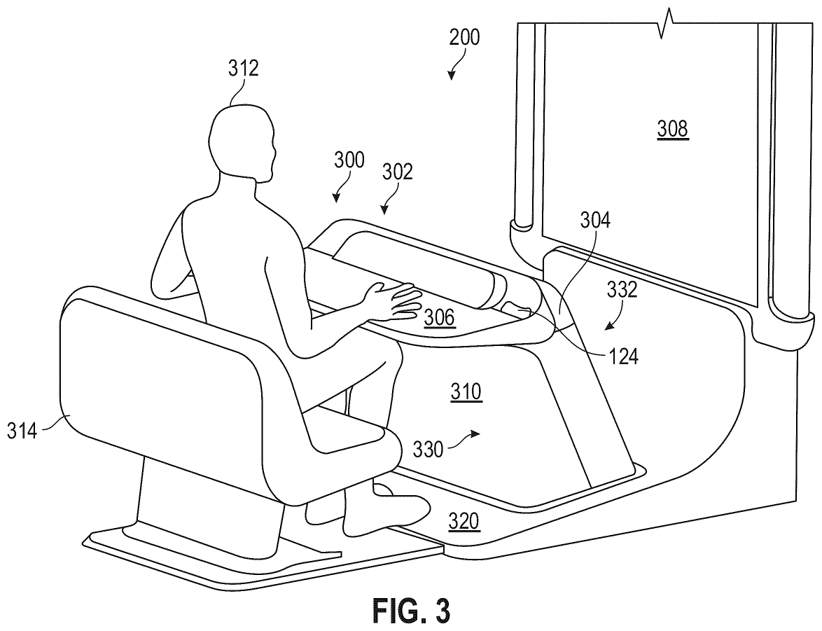

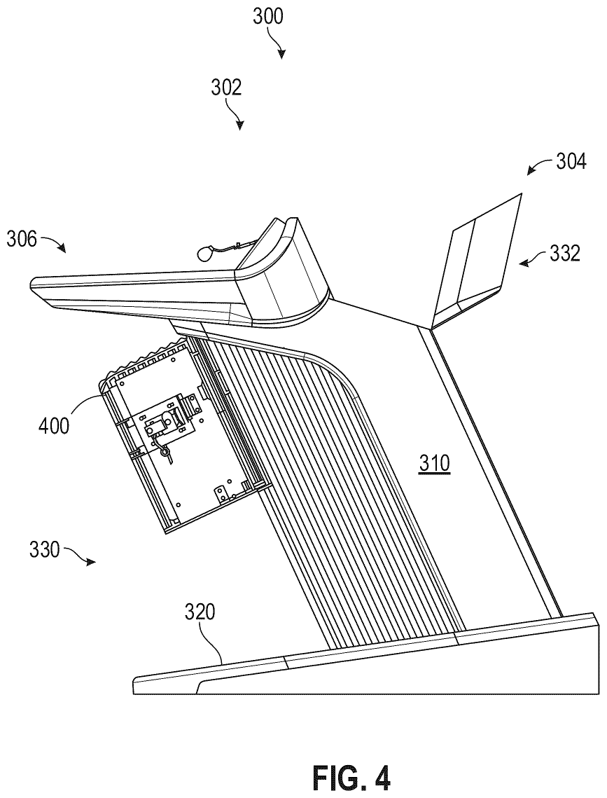

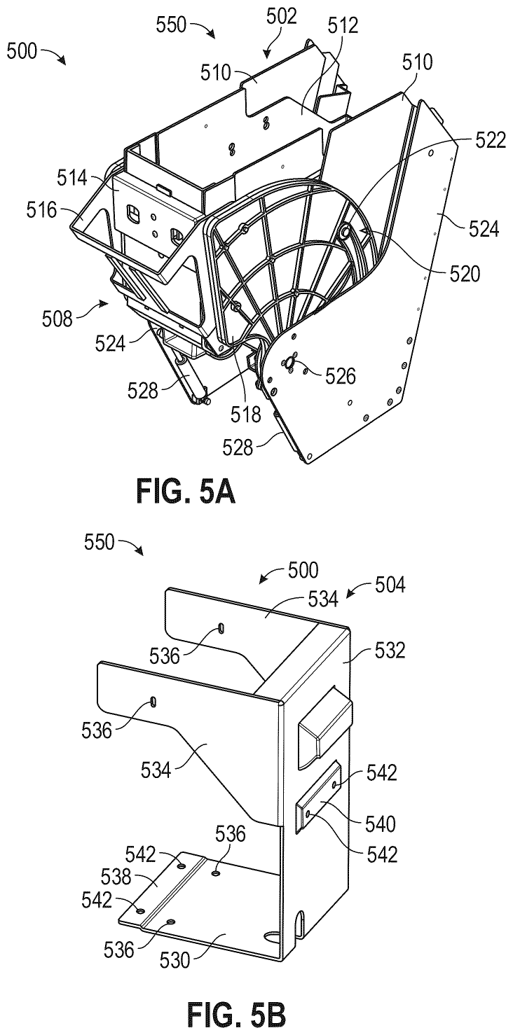

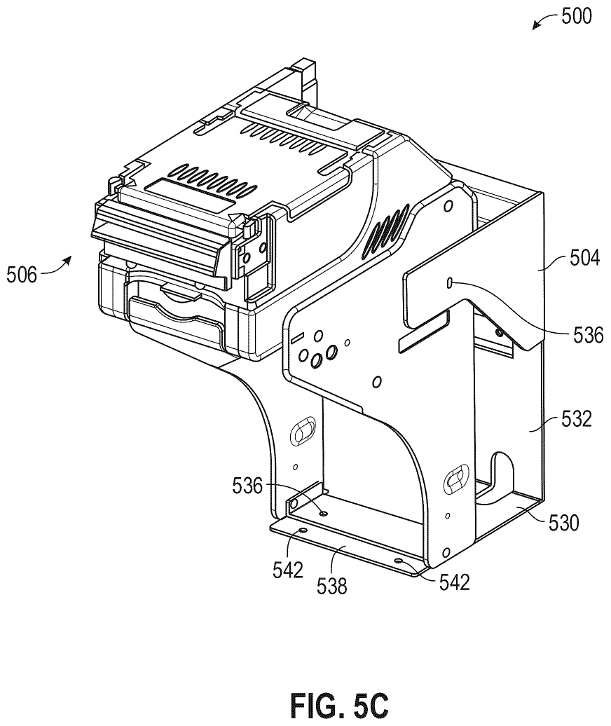

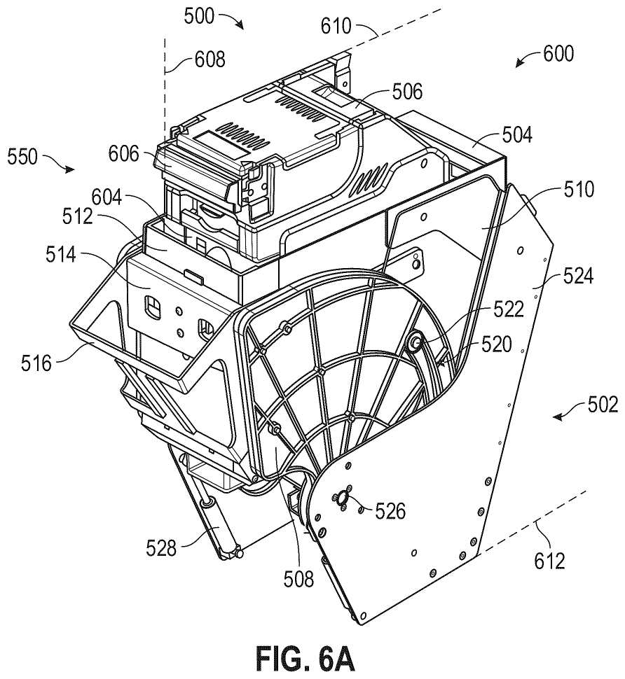

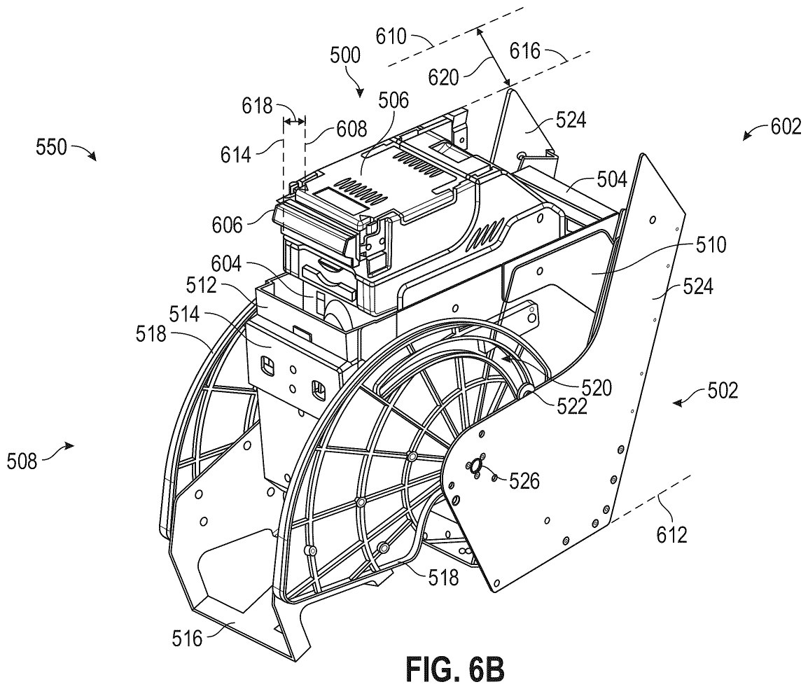

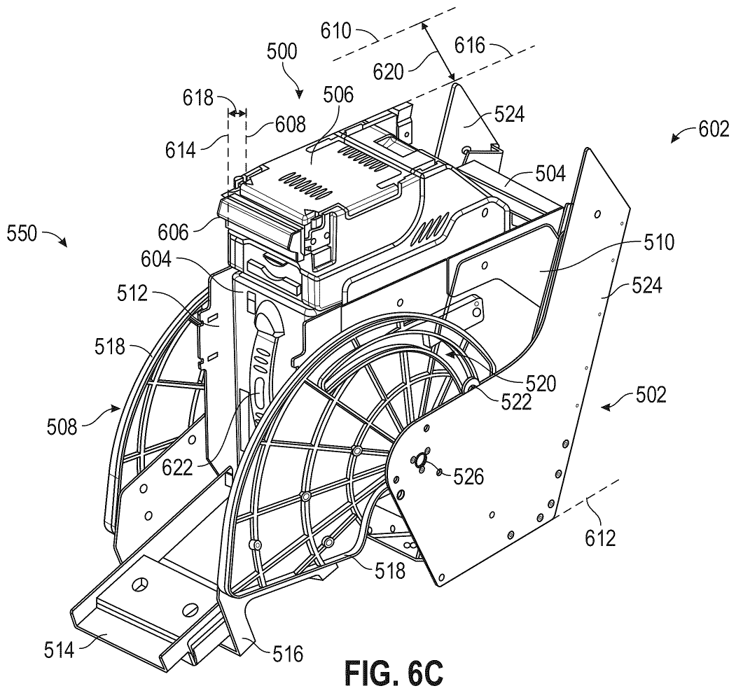

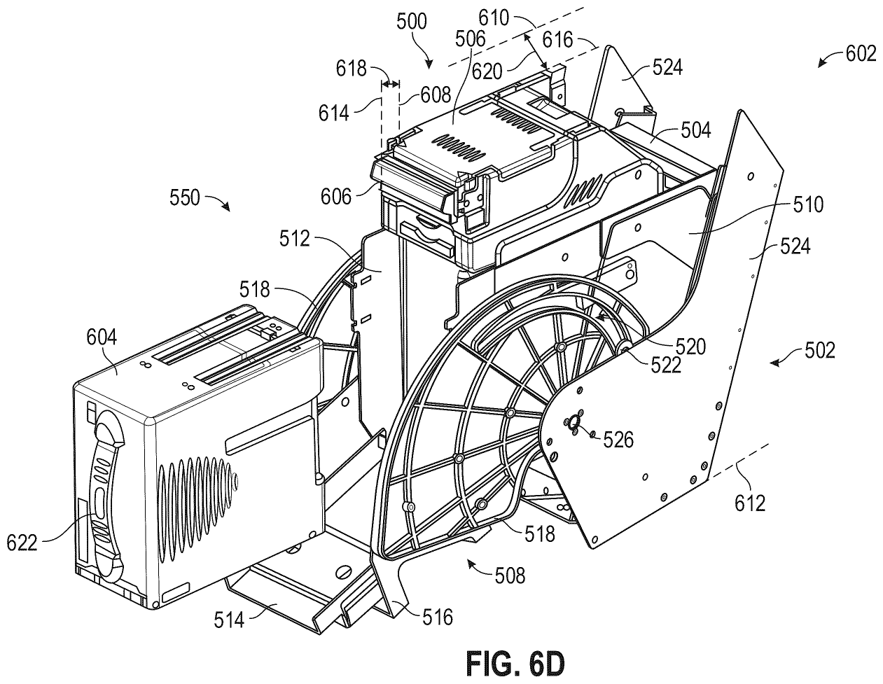

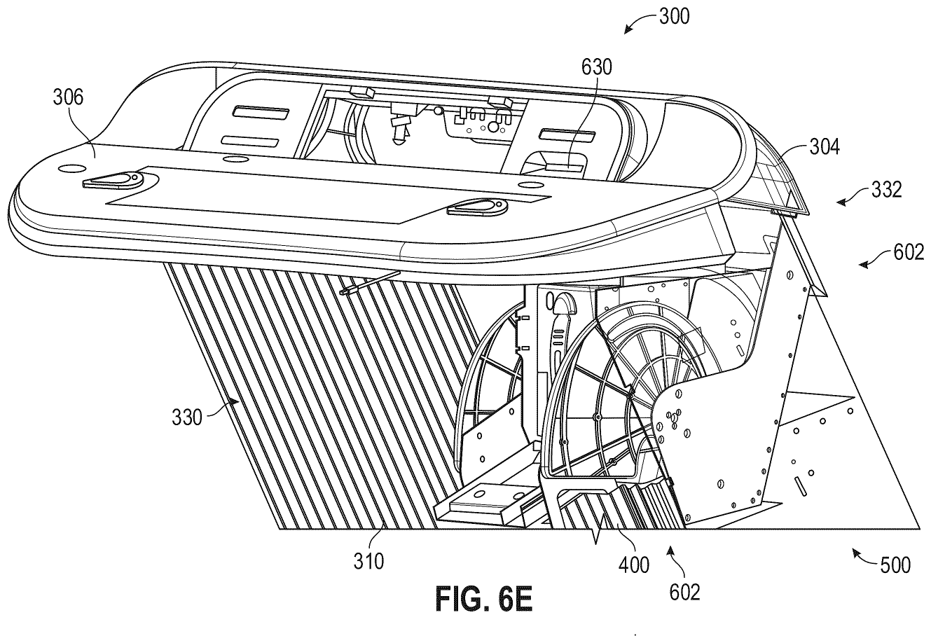

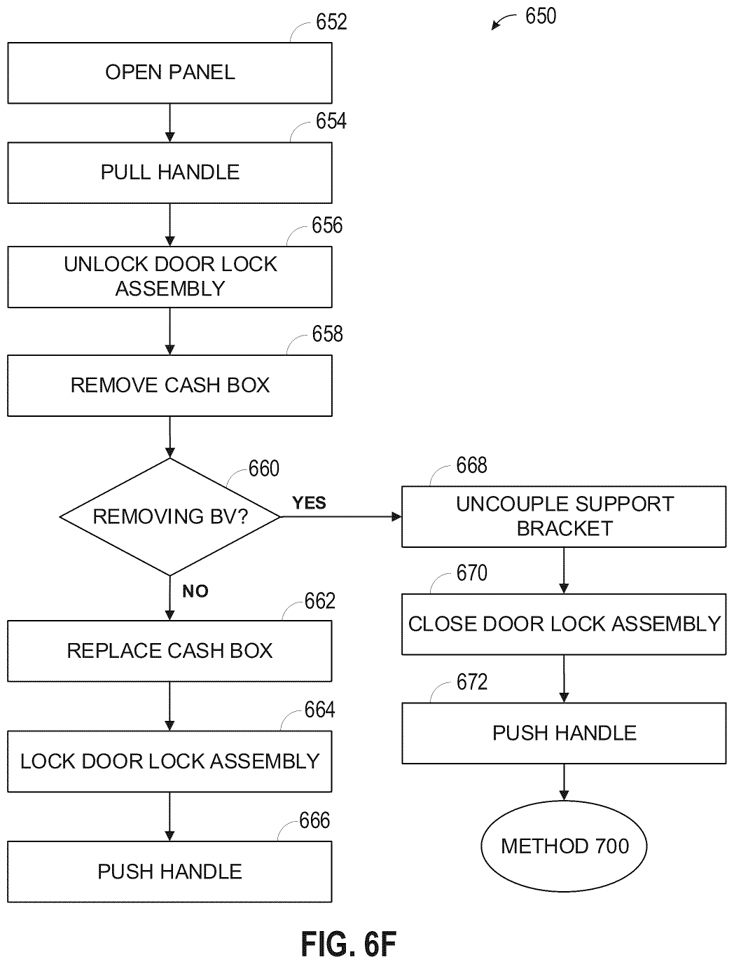

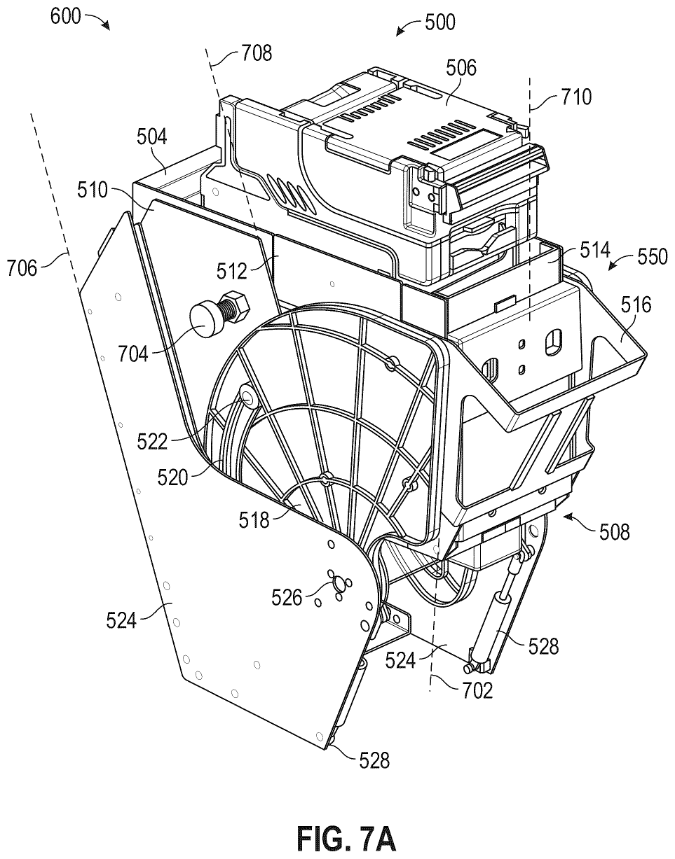

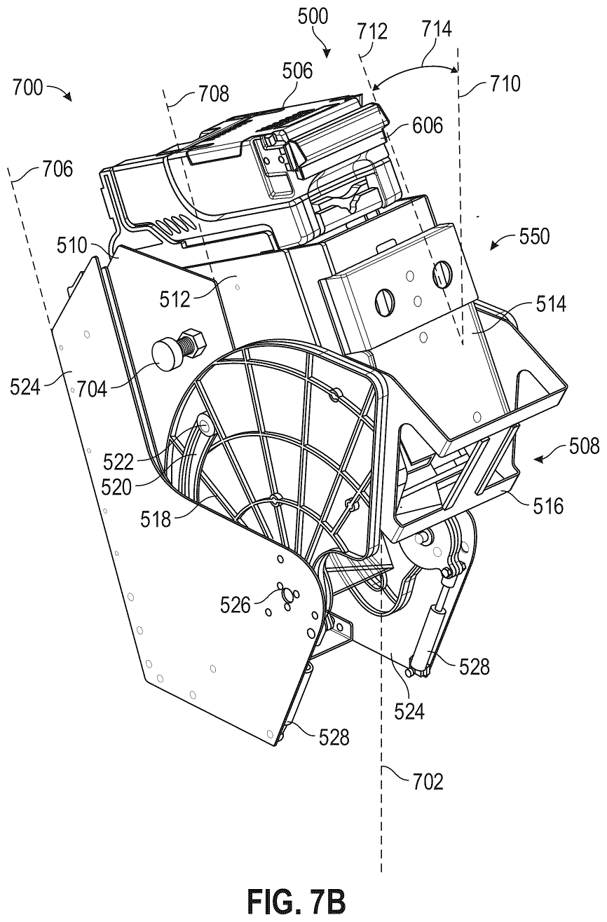

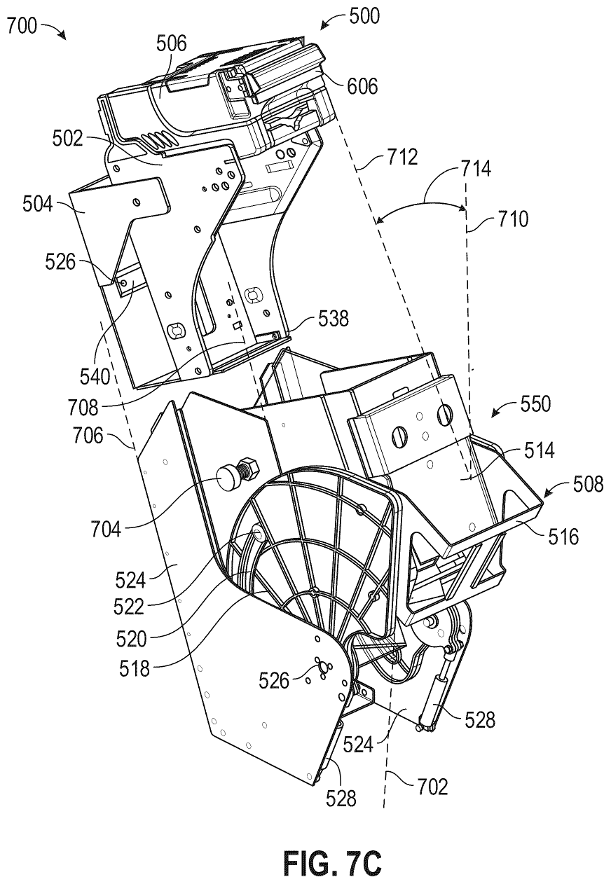

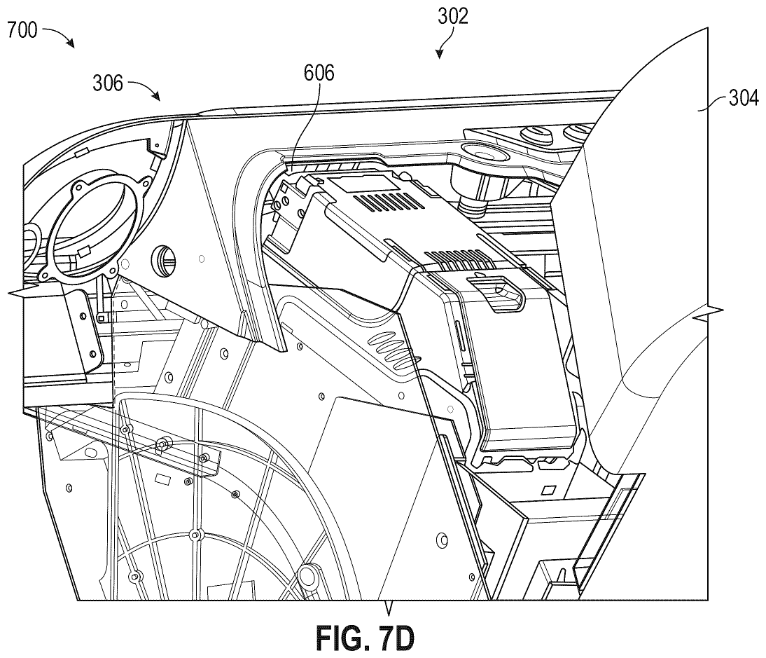

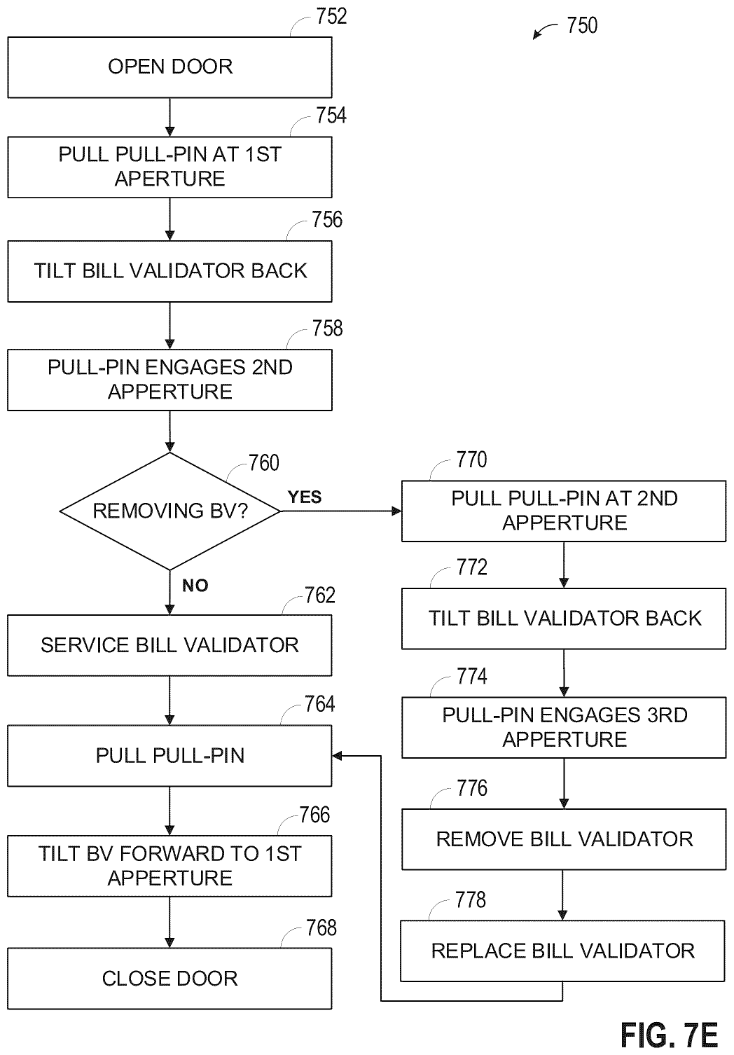

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility. A weighted table is one type of lookup table and the two terms can be used interchangeably throughout the present disclosure.

The lookup tables, in the form of weighted tables, can have one of many possible configurations. In general, a weighted table can be implemented as any data structure that assigns probabilities to different options, in order for one of the different options to be selected using a random number. Different options are represented in different entries of a weighted table. For example, there may be multiple possible values within each tier of the weighted table, and the multiple possible values may be unequally weighted. The probabilities for different options can be reflected in threshold values (e.g., for a random number RND, generated by an RNG, in the range of 1<RND<=40 for option 1, 40<RND<=70 for option 2, 70<RND<=90 for option 3, and 90<RND<=100 for option 4, given four options and a random number RND where 0<RND<=100). The threshold values can represent percentages or, more generally, sub-ranges within the range for a random number. In some example implementations, the threshold values for a weighted table are represented as count values for the respective entries of the weighted table. For example, the following table shows count values for the four options described above:

What is claimed is:

1. A bill validator mount for use with an electronic gaming machine, comprising:
an interface;
a bill validator being visible through the interface when the bill validator is at a bill insertion position, and being releasably mounted in a support bracket;
a cash box operable to be coupled to the bill validator to receive a bill in the bill insertion position; and
a cage assembly releasably receiving the support bracket with the cash box being mounted to the cage assembly via the support bracket, the bill validator being movable between the bill insertion position relative to the interface, and a servicing position away from the bill insertion position, the cage assembly being operable to tilt the bill validator a first backward position relative to the interface to the servicing position allowing access only to the bill validator for servicing while preventing access to the cash box, and to a second backward position relative to the interface to a collections position allowing access both the cash box and the bill validator.

2. The bill validator mount of claim 1, wherein the cage assembly is operable to lower the bill validator from the bill insertion position relative to the interface to the collections position to allow for removal of the cash box in the second backward position.

3. The bill validator mount of claim 1, wherein the cage assembly is operable to move the bill validator forward from the bill insertion position relative to the interface to the collections position.

4. The bill validator mount of claim 1, wherein the cage assembly includes a door lock assembly configured to secure the cash box, such that the cash box is removal when the door lock assembly is unlocked.

5. The bill validator mount of claim 4, wherein the support bracket is configured to be removably coupled to the cage assembly, such that the bill validator is only removed after the door lock assembly has been unlocked.

6. The bill validator mount of claim 4, wherein the cage assembly further includes:
a cam cage defining a plurality of cam grooves;
a linear sliding cage positioned inside the cage assembly;
a swivel cage positioned inside the linear sliding cage; and
at least two swivels coupled to the swivel cage and extending through the linear sliding cage and the cage assembly such that:
each swivel extends through a first cam groove of the plurality of cam grooves,
the swivel cage is configured to swivel relative to the linear sliding cage and the cage assembly to pivot the bill validator from the bill insertion position to the servicing position, and
the swivel is configured to follow the plurality of cam grooves to move the linear sliding cage and the swivel cage linearly from the bill insertion position to the collections position responsive to rotation of the cage assembly.

7. The bill validator mount of claim 6, wherein the cage assembly further includes a handle, such that pulling the handle causes rotation of the cage assembly.

8. An electronic gaming machine comprising:
a cabinet having a face;
a bill validator being visible on the face when the bill validator is at a bill insertion position, and being releasably mounted in a support bracket;
a cash box operable to be coupled to the bill validator to receive a bill in the bill insertion position, and to store the bill; and
a cage assembly releasably receiving the support bracket with the cash box being mounted to the cage assembly via the support bracket, the bill validator being movable between the bill insertion position relative to the face, and a servicing position away from the bill insertion position, the cage assembly being operable to tilt the bill validator to a first position relative to the face to the servicing position allowing access only to the bill validator for servicing while preventing access to the cash box, and to a second position relative to the face to a collections position allowing access to both the cash box and the bill validator, and wherein the first position is different than the second position.

9. The electronic gaming machine of claim 8, wherein the first position is away from the face.

10. The electronic gaming machine of claim 8, wherein the bill validator in the servicing position is tilted backward relative to the bill insertion position, and the bill validator in the collections position is lowered relative to the bill insertion position.

11. The electronic gaming machine of claim 8, wherein the cabinet is a pedestal cabinet.

12. The electronic gaming machine of claim 11, wherein the servicing position allows the bill validator to be serviced without opening the face, and the collections position allows the cash box to be removed without opening the face.

13. The electronic gaming machine of claim 8, wherein the cage assembly further includes a handle, such that pulling the handle causes rotation of the cage assembly.

14. The electronic gaming machine of claim 8, wherein the cage assembly further includes a door lock assembly configured to secure the cash box, such that the cash box is removal when the door lock assembly is unlocked.

15. A method for servicing an electronic gaming machine having a cabinet having a face, a bill validator being visible on the face when the bill validator is at a bill insertion position, and being releasably mounted in a support bracket, a cash box operable to store a bill, and a cage assembly, the bill validator being movable between the bill insertion position relative to the face, and a servicing position away from the bill insertion position, the method comprising:
positioning the bill validator with respect to the cash box to receive the bill in the bill insertion position;
releasably receiving the support bracket in the cage assembly;
mounting the cash box to the cage assembly via the support bracket;
tilting the bill validator in the cage assembly to a first position relative to the face to the servicing position allowing access only to the bill validator for servicing while preventing access to the cash box; and
tilting the bill validator in the cage assembly to a second position relative to the face to a collections position allowing access both the cash box and the bill validator, and wherein the first position is different than the second position.

16. The method of claim 15, further comprising pulling out a pull pin to unlock rotational movement of the bill validator prior to moving the bill validator to the servicing position.

17. The method of claim 15, wherein the electronic gaming machine further includes a door lock assembly securing the cash box, further comprising:
unlocking the door lock assembly to reveal the cash box when the bill validator is in the collections position; and
removing the cash box from the support bracket.

18. The method of claim 17, further comprising:
removably coupling the bill validator to the support bracket; and
inserting the support bracket into the cage assembly.

19. The method of claim 18, further comprising:
uncoupling the support bracket from the cage assembly at a coupling portion only accessible when the bill validator is in the collections position; and
then from the servicing position, removing the support bracket with the bill validator from the cage assembly.

20. The method of claim 15, further comprising allowing in the servicing position the bill validator to be serviced without opening the face, and in the collections position the cash box to be removed without opening the face.
